(19) United States
(12) Patent Application Publication
(10) Pub. No.: US 2026/0056715 A1
(43) Pub. Date: Feb. 26, 2026

(54) METHOD, APPARATUS, DEVICE AND STORAGE MEDIUM FOR PROCESSING A PAGE TASK

(71) Applicant: Beijing Zitiao Network Technology Co., Ltd., Beijing (CN)

(72) Inventors: Jialong Zeng, Beijing (CN); Qinghao Zhu, Beijing (CN); Junchen Ge, Beijing (CN); Chengzhang Lin, Beijing (CN); Dong Wu, Beijing (CN)

(21) Appl. No.: 18/980,290

(22) Filed: Dec. 13, 2024

(30) Foreign Application Priority Data
Aug. 23, 2024 (CN) 202411171707.9

(51) Int. Cl. G06F 8/30

(52) U.S. Cl. CPC G06F 8/311

(57) ABSTRACT

Embodiments of the disclosure provide a method, apparatus, device and storage medium for processing a page task. The method includes: obtaining a target HTML file, wherein the target HTML file includes a script code of at least one page task, the target HTML file obtained by replacing a script reference tag of the at least one page task in an original HTML file with the script code, and the script reference tag requesting the script code of the page task; extracting the script code of the at least one page task from the target HTML file; and executing the script code of the at least one page task.

### CROSS-REFERENCE

The present application claims priority to Chinese Patent Application No. 202411171707.9, filed on Aug. 23, 2024 and entitled “METHOD, APPARATUS, DEVICE AND STORAGE MEDIUM FOR PROCESSING A PAGE TASK”, the entirety of which is incorporated herein by reference.

### FIELD

Embodiments in the present disclosure relate to the field of computer technology, in particular to a method, an apparatus, a device, and a storage medium for processing a page task.

### BACKGROUND

In current applications (such as web applications), page loading speed and performance are critical factors affecting user experience. Web Worker is a technology that allows scripts to be run in threads other than the main thread, which is used to perform complex and resource-intensive tasks, thereby avoiding blocking the response of the page. However, traditional Web Worker technology usually requires to initiate additional network requests to obtain Worder scripts, which may result in slower page loading speed, especially in scenarios with high requirements for loading speed, which affects the user experience.

### SUMMARY

Embodiments in the present disclosure provides a method, apparatus, device and storage medium for processing a page task, which reduce network delay by decreasing an additional network request.

In a first aspect, the embodiment in the present disclosure provides a method for processing a page task, including: obtaining a target HTML file, where the target HTML file includes a script code of at least one page task, the target HTML file obtained by replacing a script reference tag of the at least one page task in an original HTML file with the script code, and the script reference tag requesting the script code of the page task; extracting the script code of the at least one page task from the target HTML file; and executing the script code of the at least one page task.

In a second aspect, the embodiment in the present disclosure further provides an apparatus for processing a page task, including: a target HTML file obtaining module, configured to obtain a target HTML file; where the target HTML file includes a script code of at least one page task, the target HTML file obtained by replacing a script reference tag of the at least one page task in an original HTML file with the script code, and the script reference tag requesting the script code of the page task; a script code extracting module, configured to extract the script code of at least one page task from the target HTML file; and a script code execution module, configured to execute the script code of the at least one page task.

In a third aspect, the embodiment in the present disclosure further provides an electronic device, including: one or more processors; a storage device, configured to store one or more programs; when the one or more programs executed by the one or more processors, causing the one or more processors to perform the method for processing a page task according to any one of the embodiments in the present disclosure.

In a fourth aspect, the embodiment in the present disclosure further provides a storage medium including computer-executable instructions, the computer-executable instructions, when executed by a computer processor, performing the method for processing a page task according to any one of the embodiments in the present disclosure.

The embodiments in the present disclosure provides a method, apparatus, device and storage medium for processing a page task, including: obtaining a target HTML file, where the target HTML file includes a script code of at least one page task, the target HTML file obtained by replacing a script reference tag of the at least one page task in an original HTML file with the script code, and the script reference tag requesting the script code of the page task; extracting the script code of the at least one page task from the target HTML file; executing the script code of the at least one page task. The method for processing a page task provided by the embodiments in the present disclosure, may directly extract and execute the script code of the at least one page task from the target HTML file, without requesting the script code of the page task based on the script reference tag, and reducing the additional network request, thereby improving the processing speed and efficiency of the page task.

### BRIEF DESCRIPTION OF DRAWINGS

The above and other features, advantages, and aspects of the various embodiments in the present disclosure will become more apparent in combination with the accompanying drawings with reference to the following detailed description. Throughout the drawings, the same or similar reference numbers refer to the same or similar elements. It should be understood that the drawings are schematic, and components and elements are not necessarily drawn to scale.

FIG. 1 is a schematic flowchart of a method for processing a page task provided by the embodiments in the present disclosure;

FIG. 2 is a schematic structural diagram of an apparatus for processing a page task provided by the embodiments in the present disclosure;

FIG. 3 is a schematic structural diagram of an electronic device according to an embodiment in the present disclosure.

### DETAILED DESCRIPTION

Embodiments in the present disclosure will be described in more detail below with reference to the accompanying drawings. Although certain embodiments in the present disclosure are shown in the drawings, it would be appreciated that the present disclosure may be implemented in various forms and should not be interpreted as limited to the embodiments described in this specification. On the contrary, these embodiments are provided for a more thorough and complete understanding in the present disclosure. It would be appreciated that the accompanying drawings and the embodiments in the present disclosure are only for the purpose of illustration and are not intended to limit the scope of protection in the present disclosure.

It should be understood that the respective steps described in the detailed description in the present disclosure may be performed in different orders, and/or in parallel. Further, the detailed description may include additional steps and/or steps whose illustration is omitted. The scope in the present disclosure is not limited in this respect.

As used herein, the term “comprising” and its variations are open-ended inclusion, i.e., “including but not limited to”. The term “based on” is “at least partially based on”. The term “one embodiment” represents “at least one embodiment”; the term “another embodiment” represents “at least one additional embodiment”; the term “some embodiments” represent “at least some embodiments”. The relevant definitions of other terms will be provided in the following description.

It should be noted that the concepts of “first” and “second”, etc., mentioned in the present disclosure are only used to distinguish different apparatuses, modules, or units, and are not intended to limit the order of functions performed by these apparatuses, modules, or units or the mutual dependency relationship.

It should be noted that the modification of “a” and “a plurality” mentioned in the present disclosure is illustrative and non-limiting, and one skilled in the art should appreciate that, unless explicitly indicated in the context, otherwise they should be understand as “one or more”.

The names of messages or information exchanged between a plurality of apparatuses in the detailed description in the present disclosure are used for illustrative purposes only and are not intended to limit the scope of these messages or information.

It would be understood that, before using the technical solutions disclosed by the embodiments in the present disclosure, the types, the usage scope, the usage scenarios and the like, of personal information related to the present disclosure involved in the present disclosure should be notified to the user in an appropriate manner according to the relevant laws and regulations, and the authorization of the user should be obtained.

For example, in response to an active request being received from users, a prompt message is sent to the user to explicitly prompt the user that the operation requested by the user would need acquisition and use of personal information of the user. As such, according to prompt information, users may choose whether to provide personal information to the software or hardware, such as an electronic device, application, server or storage medium, that performs the operations of the technical solution in the present disclosure.

As an optional but non-limiting implementation, in response to the active request being received from the user, the prompt information may be sent to the user via, for example, a pop-up window in which the prompt information may be presented in text. In addition, the pop-up window may also contain selection controls configured for the user to choose “agree” or “disagree” to provide the personal information to the electronic device.

It would be appreciated that the above process of notification and acquisition of user authorization is only an example and do not limit the implementations in the present disclosure. Other methods that meet relevant laws and regulations may also be applied to the implementations in the present disclosure.

It would be understood that the data involved in the technical solution (including but not limited to the data itself, the acquisition or use of the data) should comply with the requirements of corresponding laws, regulations and relevant provisions.

In the prior art, an external script file is generally referenced in an HTML file through a script reference tag to create a page task instance, in which a new network request is required to initiate to obtain the external script file. The page task may be a Web Worker task, and the representation of the script reference tag may be: “new Worker (‘worker.js’)”, and the external script file may be a JavaScript file. Each independent Worker script requires an individual network request to obtain, which increases the number of requests and network latency, thereby affecting the performance of page loading speed.

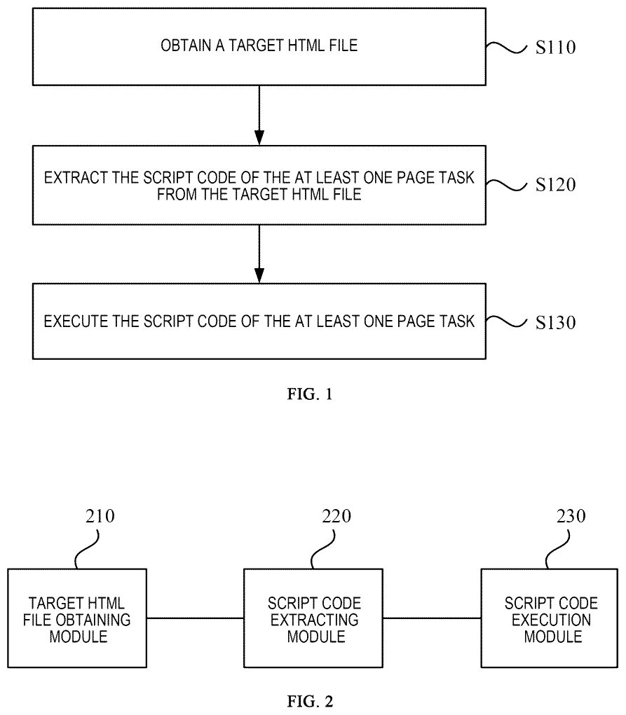

FIG. 1 is a schematic flowchart of a method for processing a page task provided by the embodiments in the present disclosure. The embodiments in the present disclosure are applicable to scenarios of processing the page task. The method may be performed by an apparatus for processing the page task. The apparatus may be performed in the form of software and/or hardware, optionally may be performed by an electronic device. The electronic device may be a mobile terminal, a PC terminal, or a server and the like.

As shown in FIG. 1, the method includes the following.

S110, obtaining a target HTML file.

The target HTML (Hypertext Markup Language) file includes a script code of at least one page task, the target HTML file obtained by replacing a script reference tag of the at least one page task in an original HTML file with the script code, and the script reference tag requesting the script code of the page task.

The page task may also be referred to as a web page task, which is a task other than a page interaction task, for example, may be a resource computing task, a resource pulling task, a resource uploading task and the like. In this embodiment, the page task may be a Web Worker task. The target HTML file including a script code of at least one page task may be understood as: the target HTML file contains inline or embedded script code of the at least one page task. The script code of the page task may be understood as the program code written in a configured programming language within an execution script of the page task, and the page task is executed by running the script code.

The script reference tag may be a task object created with a predetermined task construction function, and the parameter in the task object is a uniform resource locator (URL) of the script file of the page task. For example, assuming that the page task is a Web Worker task, and the script file of the page task is a JS file, the Worker construction function is configured to create a Worker object, and the parameter in the Worker object is the URL of the JS file. In the original HTML file, the script code, corresponding to the page task and requested based on the script reference tag, may be run to execute the corresponding page task.

In this embodiment, the target HTML file is pre-compiled. Specifically, the pre-compilation manner is: extracting the script reference tag of the at least one page task from the original HTML file; replacing the script reference tag in the original HTML file with the script code of a corresponding page task to obtain the target HTML file; where the script code is a code in a script file of the page task.

In this embodiment, the original HTML file is firstly parsed with a compiler, and the script reference tag represented by the task object is searched from the original HTML file. Then codes in the script file corresponding to the page task is read with the compiler to obtain the script code. And finally the script reference tag is deleted, and the script code is added to the position where the original script reference tag is located, that is, the script reference tag is replaced with the script code to obtain the target HTML file.

Optionally, the manner for replacing the script reference tag in the original HTML file with the script code of a corresponding page task to obtain the target HTML file may be: reading the code from the script file of the page task to obtain the script code; adding a predetermined code label to the read script code; replacing the script reference tag in the original HTML file with the corresponding script code added with the predetermined code label to obtain the target HTML file.

The predetermined code label may be a label predetermined by a developer, containing a predetermined string to identify the script code of the page task. For example, the form of the predetermined code label may be: “predetermined string:”. The manner for reading the code from the script file of the page task may be: reading the code in the script file of the page task with the compiler. The manner for adding a predetermined code label to the read script code may be: adding the predetermined code label before the script code. For example, it may be represented as: “predetermined string: script code”. Finally, the script reference tag in the original HTML file is replaced with the corresponding script code added with the predetermined code label to obtain the target HTML file. For example, assuming that the script reference label of the page task in the original HTML file is represented as: <label> script reference label </label>, the script code of the page task in the compiled target HTML file is represented as: <label> predetermined string: script code </label>. In this embodiment, the predetermined code label is added to the read script code to facilitate the identification and extraction for the script code of the page task, thereby improving the execution efficiency of the page task. In this embodiment, replacing the script reference tag of the page task in the original HTML file with the script code, that is, embedding the script code of the page task into the HTML file directly, may avoid extra network requests, thereby reducing the network latency and improving the page loading speed, and with a better effect especially when the network is in poor condition or the latency is high. Meanwhile, the request for the script file of an individual page task is reduced, thereby reducing the load of the server and increasing the utilization of the network resource.

Optionally, after replacing the script reference tag in the original HTML file with the corresponding script code added with the predetermined code label, the method further includes the following step: modifying configuration information of the HTML file from the script reference tag of the page task contained in the HTML file to the script code of the page task contained in the HTML file.

The configuration information of the HTML file may be configuration information of the manner for embedding the page task into the HTML file. The script reference tag of the page task contained in the HTML file represents that the manner for embedding the page task into the HTML file is embedding the script reference tag into the HTML file; the script code of the page task contained in the HTML file represents that the manner for embedding the page task into the HTML file is embedding the script code of the page task into the HTML file.

In this embodiment, when the page task is executed, in the HTML file, the configuration information of the manner for embedding the page task into the HTML file is read first, and if the configuration information is the script code of the page task contained in the HTML file, the script code of the page task is directly extracted from the HTML file; if the configuration information is the script reference tag of the page task contained in the HTML file, the network request needs to be initiated based on the script reference tag to request the script code of the page task. In this embodiment, while replacing the script reference tag in the HTML file with the script code, the corresponding configuration information is modified, so that the version control and caching strategy is more consistent and efficient.

S120, extracting the script code of the at least one page task from the target HTML file.

In this embodiment, since the predetermined code label is added to the script code of the page task, the script code of the page task may be first searched from the target HTML file based on the predetermined code label, and then the searched script code is extracted. The manner for searching the script code of the page task from the target HTML file based on the predetermined code label may be: searching through matching the predetermined code label with the content in the target HTML file.

Optionally, the manner for extracting the script code of the at least one page task from the target HTML file may be: traversing content in the target HTML file, and matching the traversed content with the predetermined code label; if the traversed content matches the predetermined code label, extracting the script code corresponding to the traversed content.

In this embodiment, the content in the target HTML file is traversed sequentially from front to back, and the traversed content is compared with the predetermined code label. If the traversed content is the same as the predetermined code label, it indicates that the content corresponding to the predetermined code label in the target HTML file is the script code of the page task to be determined. And finally the determined script code of the page task is extracted. In this embodiment, there is no need to parse the HTML file one by one, the script code of the at least one page task is directly extracted from the target HTML file based on the predetermined code label. The method not only saves computing resources but also improves the efficiency of script code extraction, thereby increasing the execution speed of the page task.

S130, executing the script code of the at least one page task.

Executing the script code of the at least one page task may be understood as running the script code of individual page task, to perform the function corresponding to individual script code, that is, to execute the corresponding page task.

Optionally, the manner for executing the script code of the at least one page task may be: creating at least one page task instance based on the script code; and loading the page task instance into at least one created thread for execution.

The at least one thread corresponds to the at least one page task instance with a one-to-one relationship, that is, one page task is executed by one thread, so that the execution efficiency of the page task may be improved. The thread executing the page task instance may be pre-created or created after extracting the script code of the page task The embodiment does not limit the timing of thread creation. Specifically, after obtaining the script code of the page task, the page task instance is created based on the script code, and the page task instance is loaded into the created thread for execution, that is, the function corresponding to the page task is performed. In this embodiment, when the page task is executed, the script code of the page task is directly extracted from the HTML file, and the page task instance is created and executed, to ensure correct execution of the script code.

In this scenario, while processing the page task, the target HTML file may be parsed to load the page, that is, the loading of the HMTL file and the executing of the page task may be executed synchronously. When the HTML file is loaded, a page loading thread needs to be created, the page loading thread may serve as a main thread, and the thread executing the page task instance may serve as a sub-thread. When the sub-thread is created, a communication connection with the main thread needs to be established for data communication between the main thread and the sub-thread. In this embodiment, the embedded script code may be synchronously executed with the HTML file, so that the page may be rendered more quickly for the first time, enabling the user to view the page content more quickly, thereby reducing the waiting time and improving the user experience.

Optionally, after loading the page task instance into the created thread for execution, the method further includes: detecting an execution state of the page task instance executed in an individual thread; storing the execution state in a message queue of the individual thread.

The execution state includes a normal state or an abnormal state. In this embodiment, each thread executing the page task instance maintains a message queue storing the execution state of the page task instance. The execution state of the page task instance executed in individual thread may be dynamically detected through a state monitoring mechanism. When the execution state is the abnormal state, the abnormal state is written into the corresponding message queue. When the thread executing the page task instance receives a state request sent by the main thread, the execution state stored in the message queue is sent to the main thread. Compared to the method in the prior art that the abnormal state is sent to the main thread as soon as it is detected, in the embodiment, the abnormal state is firstly stored in the message queue, then all of the abnormal states in the message queue are sent to the main thread based on the state request from the main thread, thereby saving significantly the overhead of cross-thread communication.

In the solution of the embodiment, the script code of the page task is directly embedded into the HTML file to avoid extra network requests, thereby reducing the network latency and improving the page loading speed, and with a better effect especially when the network is in poor condition or the latency is high. Meanwhile, the request for the script file of the individual page task is reduced, thereby reducing the load of the server and improving the utilization of the network resource. While replacing the script reference tag in the HTML file with the script code, the corresponding configuration information is modified, so that the version control and caching strategy is more consistent and efficient. When the page task is executed, the script code of the page task is directly extracted from the HTML file, and the page task instance is created and executed, to ensure correct operation of the script code. The embedded script code may be synchronously executed with the HTML file, so that the page may be rendered more quickly for the first time, enabling the user to view the page content more quickly, thereby reducing the waiting time and improving the user experience.

The technical solution of the embodiments in the present disclosure includes: obtaining a target HTML file, where the target HTML file includes a script code of at least one page task, the target HTML file obtained by replacing a script reference tag of the at least one page task in an original HTML file with the script code, and the script reference tag requesting the script code of the page task; extracting the script code of the at least one page task from the target HTML file; executing the script code of the at least one page task. In the method for processing a page task provided by the embodiment in the present disclosure, the script code of the at least one page task may be directly extracted from the target HTML file for execution, without requesting the script code of the page task based on the script reference tag, thereby reducing the extra network request and improving the speed and efficiency for processing the page task.

FIG. 2 is a schematic structural diagram of an apparatus for processing a page task provided by the embodiments in the present disclosure, as shown in FIG. 2, the apparatus includes: a target HTML file obtaining module 210, configured to obtain a target HTML file; where the target HTML file includes a script code of at least one page task, the target HTML file obtained by replacing a script reference tag of the at least one page task in an original HTML file with the script code, and the script reference tag requesting the script code of the page task; a script code extracting module, configured to extract the script code of at least one page task from the target HTML file; a script code execution module, configured to execute the script code of the at least one page task.

Optionally, the target HTML file is pre-compiled, and the apparatus further includes: a pre-compiling module, configured to: extract the script reference tag of the at least one page task from the original HTML file; replace the script reference tag in the original HTML file with the script code of a corresponding page task to obtain the target HTML file; where the script code is a code in a script file of the page task.

Optionally, the pre-compiling module is further configured to: read the code from the script file of the page task to obtain the script code; add a predetermined code label to the read script code; replace the script reference tag in the original HTML file with the corresponding script code added with the predetermined code label to obtain the target HTML file.

Optionally, the script code extracting module 220 is further configured to: traverse content in the target HTML file, and match the traversed content with the predetermined code label; if the traversed content matches the predetermined code label, extract the script code corresponding to the traversed content.

Optionally, the apparatus further includes: a configuration information modifying module, configured to: modify configuration information of the HTML file from the script reference tag of the page task contained in the HTML file to the script code of the page task contained in the HTML file.

Optionally, the script code execution module 230 is further configured to: create at least one page task instance based on the script code; load the page task instance into at least one created thread for execution; where the at least one thread corresponds one-to-one with the at least one page task instance.

Optionally, the apparatus further includes an execution state detecting module, configured to: detect an execution state of the page task instance executed in an individual thread; store the execution state in a message queue of the individual thread.

The apparatus for processing a page task provided by the embodiments in the present disclosure may perform the method for processing a page task provided by any embodiment in the present disclosure, and has functional modules and beneficial effects corresponding to the execution method.

It should be noted that the units and modules included in the foregoing apparatus are divided only according to the function logic, but are not limited to the foregoing division, as long as the corresponding functions may be implemented; in addition, the specific names of the functional units are merely for ease of distinguishing, and are not intended to limit the protection scope of the embodiments in the present disclosure.

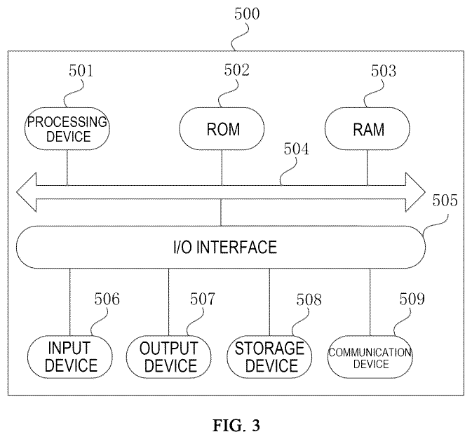

FIG. 3 is a schematic structural diagram of an electronic device according to an embodiment in the present disclosure. Referring to FIG. 3, it illustrates is a schematic structural diagram of an electronic device 500 (for example the terminal device or server in FIG. 3) suitable for implementing the embodiments in the present disclosure. The terminal device in the embodiments in the present disclosure may include, but is not limited to, a mobile terminal such as a mobile phone, a notebook computer, a digital broadcast receiver, a PDA (personal digital assistant), a PAD (tablet computer), a PMP (portable multimedia player), an in-vehicle terminal (for example, an in-vehicle navigation terminal), and a fixed terminal such as a digital TV, a desktop computer, or the like. The electronic device shown in FIG. 3 is merely an example, and should not impose any limitation on the functions and scope of usage of the embodiments in the present disclosure.

As shown in FIG. 3, the electronic device 500 may include a processing device (for example, a central processing unit, a graphics processor, etc.) 501, which may perform various appropriate actions and processing according to a program stored in a read-only memory (ROM) 502 or a program loaded into a random access memory (RAM) 503 from a storage device 508. In the RAM 503, various programs and data required by the electronic device 500 are also stored. The processing device 501, the ROM 502, and the RAM 503 are connected to each other through a bus 504. An input/output (I/O) interface 505 is also connected to the bus 504.

Generally, the following devices may be connected to the I/O interface 505: an input device 506 including, for example, a touch screen, a touchpad, a keyboard, a mouse, a camera, a microphone, an accelerometer, a gyroscope, etc.; an output device 507 including, for example, a liquid crystal display (LCD), a speaker, a vibrator, etc.; a storage device 508 including, for example, a magnetic tape, a hard disk, etc.; and a communication device 509. The communication device 509 may allow the electronic device 500 to communicate wirelessly or wired with other devices to exchange data. While FIG. 3 shows an electronic device 500 having various devices, it should be understood that it is not required to implement or have all illustrated devices. More or fewer devices may alternatively be implemented or provided.

In particular, according to the embodiments in the present disclosure, the process described above with reference to the flowchart may be implemented as a computer software program. For example, the embodiments in the present disclosure include a computer program product including a computer program carried on a non-transitory computer readable medium. The computer program contains program code for performing the method shown in the flowchart. In such embodiments, the computer program may be downloaded and installed from the network through the communication device 509, or installed from the storage device 508 or the ROM 502. When the computer program is executed by the processing device 501, the foregoing functions defined in the method of the embodiments in the present disclosure are performed.

The names of messages or information exchanged between a plurality of apparatus in embodiments in the present disclosure are for illustrative purposes only and are not intended to limit the scope of such messages or information.

The electronic device provided by the embodiments in the present disclosure and the method for processing the page task provided in the foregoing embodiments belong to the same inventive concept, and technical details not described in detail in the embodiment may refer to the foregoing embodiments, and the embodiment has the same beneficial effects as the foregoing embodiments.

The embodiments in the present disclosure provides a computer storage medium having a computer program stored thereon, the program, when executed by a processor, performs method for processing the page task provided in the foregoing embodiments.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, apparatus, or device, or any combination thereof. More specific examples of computer-readable storage media may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program used by or used in connection with an instruction execution system, apparatus, or device. The program code contained on the computer-readable medium may be transmitted with any suitable medium, including, but not limited to: wires, optical cables, RF (radio frequency), and the like, or any suitable combination of the foregoing.

In some implementations, the client, server may communicate utilizing any currently known or future developed network protocol, such as HTTP (HyperText Transfer Protocol), and may be interconnected with any form or medium of digital data communication (e.g., communication networks). Examples of communication networks include local area networks (“LANs”), wide area networks (“WANs”), internets (e.g., the Internet), and peer-to-peer networks (e.g., ad hoc peer-to-peer networks), as well as any currently known or future developed networks.

The computer-readable medium described above may be contained in the electronic device; or may be individual existing without being assembled into the electronic device.

The computer-readable medium carries one or more programs, and when the one or more programs are executed by the electronic device, causing the electronic device to: obtain a target HTML file, where the target HTML file includes a script code of at least one page task, the target HTML file obtained by replacing a script reference tag of the at least one page task in an original HTML file with the script code, and the script reference tag requesting the script code of the page task; extract the script code of the at least one page task from the target HTML file; and execute the script code of the at least one page task.

Computer program codes for performing the embodiments in the present disclosure may be written in one or more programming languages or a combination thereof, including, but not limited to, object oriented programming languages such as Java, Smalltalk, C++, and conventional procedural programming languages, such as the “C” language or similar programming languages. The program code may execute entirely on a user's computer, partially on a user's computer, as a stand-alone software package, partially on a user's computer and partially on a remote computer, or entirely on a remote computer or server. When a remote computer is involved, the remote computer may be connected to the user's computer through any kind of network, including a local area network (LAN) or a wide area network (WAN), or may be connected to an external computer (e.g., connected through the Internet with an Internet service provider).

The flowcharts and block diagrams in the accompanying drawings illustrate architecture, function, and operation of possible implementations of systems, methods, and computer program products according to various embodiments in the present disclosure. In this regard, each block in the flowchart or block diagram may represent a module, program segment, or a portion of codes that contains one or more executable instructions for performing the specified logical function. It should also be noted that in some alternative implementations, the functions noted in the blocks may also occur in an order different from that illustrated in the drawings. For example, two blocks represented consecutively may actually be performed substantially in parallel, which may sometimes be performed in the reverse order, depending on the function involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments in the present disclosure may be implemented in software, or may be implemented in hardware. The names of the units do not, in certain cases, constitute limitations on the units themselves. For example, the first obtaining unit may be further described as “a unit obtaining at least two Internet Protocol addresses”.

The functions described above may be performed, at least partially, by one or more hardware logic components. For example, without limitation, example types of hardware logic components that may be used include: field programmable gate arrays (FPGAs), application specific integrated circuits (ASICs), application specific standard products (ASSPs), system-on-a-chip (SOCs), complex programmable logic devices (CPLDs), and the like.

In the context in the present disclosure, a machine-readable medium may be a tangible medium that may contain or store a program used by or used in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

The above description is merely an illustration of the preferred embodiments in the present disclosure and the applied technical principles. It should be understood by those skilled in the art that the related scope of the present disclosure is not limited to the technical solutions of the specific combination of the above technical features, and should also cover other technical solutions formed by any combination of the above technical features or their equivalent features without departing from the above disclosed concept. For example, the technical solutions formed by mutually replacing the features mentioned above with the technical features having similar functions disclosed also in the present disclosure (but not limited to).

Further, while individual operations are depicted in a particular order, this should not be understood as requiring that these operations be performed in the particular order shown or in sequential order. In certain circumstances, multitasking and parallel processing may be advantageous. Likewise, while several specific implementation details are contained in the discussion above, these should not be construed as limiting the scope of the present disclosure. Certain features described in the context of individual embodiments may also be implemented in combination within a single embodiment. Conversely, the various features described in the context of a single embodiment may also be implemented in a plurality of embodiments either individually or in any suitable sub-combination.

Although the present subject matter has been described in language specific to structural features and/or methodological acts, it is to be understood that the subject matter defined in the appended claims is not necessarily limited to the specific features or acts described above. Conversely, the specific features and acts described above are merely example forms of implementing the claims.

I/We claim:

1. A method for processing a page task, comprising:
obtaining a target HTML file, wherein the target HTML file comprises a script code of at least one page task, the target HTML file obtained by replacing a script reference tag of the at least one page task in an original HTML file with the script code, and the script reference tag requesting the script code of the page task;
extracting the script code of the at least one page task from the target HTML file; and
executing the script code of the at least one page task.

2. The method of claim 1, wherein the target HTML file is pre-compiled, and a manner of the pre-compiling is:
extracting the script reference tag of the at least one page task from the original HTML file; and
replacing the script reference tag in the original HTML file with the script code of a corresponding page task to obtain the target HTML file; wherein the script code is a code in a script file of the page task.

3. The method of claim 2, wherein replacing the script reference tag in the original HTML file with the script code of the corresponding page task to obtain the target HTML file comprises:
reading the code from the script file of the page task to obtain the script code;
adding a predetermined code label to the read script code; and
replacing the script reference tag in the original HTML file with the corresponding script code added with the predetermined code label to obtain the target HTML file.

4. The method of claim 3, wherein extracting the script code of the at least one page task from the target HTML file comprises:
traversing content in the target HTML file, and matching the traversed content with the predetermined code label; and
if the traversed content matches the predetermined code label, extracting the script code corresponding to the traversed content.

5. The method of claim 2, wherein after replacing the script reference tag in the original HTML file with the script code of the corresponding page task, the method further comprises:
modifying configuration information of the HTML file from the script reference tag of the page task contained in the HTML file to the script code of the page task contained in the HTML file.

6. The method of claim 1, wherein executing the script code of the at least one page task comprises:
creating at least one page task instance based on the script code;
loading the page task instance into at least one created thread for execution; wherein the at least one thread corresponds one-to-one with the at least one page task instance.

7. The method of claim 6, wherein after loading the at least one page task instance into the at least one created thread for execution, the method further comprises:
detecting an execution state of the page task instance executed in an individual thread; and
storing the execution state in a message queue of the individual thread.

8. An electronic device, comprising:
one or more processors;
a storage device, configured to store one or more programs;
when the one or more programs executed by the one or more processors, causing the one or more processors to perform acts for processing a page task comprising:
obtaining a target HTML file, wherein the target HTML file comprises a script code of at least one page task, the target HTML file obtained by replacing a script reference tag of the at least one page task in an original HTML file with the script code, and the script reference tag requesting the script code of the page task;
extracting the script code of the at least one page task from the target HTML file; and
executing the script code of the at least one page task.

9. The device of claim 8, wherein the target HTML file is pre-compiled, and a manner of the pre-compiling is:
extracting the script reference tag of the at least one page task from the original HTML file;
replacing the script reference tag in the original HTML file with the script code of a corresponding page task to obtain the target HTML file; wherein the script code is a code in a script file of the page task.

10. The device of claim 9, wherein replacing the script reference tag in the original HTML file with the script code of the corresponding page task to obtain the target HTML file comprises:
reading the code from the script file of the page task to obtain the script code;
adding a predetermined code label to the read script code; and
replacing the script reference tag in the original HTML file with the corresponding script code added with the predetermined code label to obtain the target HTML file.

11. The device of claim 10, wherein extracting the script code of the at least one page task from the target HTML file comprises:
traversing content in the target HTML file, and matching the traversed content with the predetermined code label; and
if the traversed content matches the predetermined code label, extracting the script code corresponding to the traversed content.

12. The device of claim 9, wherein after replacing the script reference tag in the original HTML file with the script code of the corresponding page task, the acts further comprises:
modifying configuration information of the HTML file from the script reference tag of the page task contained in the HTML file to the script code of the page task contained in the HTML file.

13. The device of claim 8, wherein executing the script code of the at least one page task comprises:
creating at least one page task instance based on the script code; and
loading the page task instance into at least one created thread for execution; wherein the at least one thread corresponds one-to-one with the at least one page task instance.

14. The device of claim 13, wherein after loading the at least one page task instance into the at least one created thread for execution, the acts further comprises:
detecting an execution state of the page task instance executed in an individual thread; and
storing the execution state in a message queue of the individual thread.

15. A non-transitory storage medium comprising computer-executable instructions, the computer-executable instructions, when executed by a computer processor, performing the acts for processing a page task comprising:
obtaining a target HTML file, wherein the target HTML file comprises a script code of at least one page task, the target HTML file obtained by replacing a script reference tag of the at least one page task in an original HTML file with the script code, and the script reference tag requesting the script code of the page task;
extracting the script code of the at least one page task from the target HTML file; and
executing the script code of the at least one page task.

16. The non-transitory storage medium of claim 15, wherein the target HTML file is pre-compiled, and a manner of the pre-compiling is:
extracting the script reference tag of the at least one page task from the original HTML file; and
replacing the script reference tag in the original HTML file with the script code of a corresponding page task to obtain the target HTML file; wherein the script code is a code in a script file of the page task.

17. The non-transitory storage medium of claim 16, wherein replacing the script reference tag in the original HTML file with the script code of the corresponding page task to obtain the target HTML file comprises:
reading the code from the script file of the page task to obtain the script code;
adding a predetermined code label to the read script code; and
replacing the script reference tag in the original HTML file with the corresponding script code added with the predetermined code label to obtain the target HTML file.

18. The non-transitory storage medium of claim 17, wherein extracting the script code of the at least one page task from the target HTML file comprises:
traversing content in the target HTML file, and matching the traversed content with the predetermined code label; and
if the traversed content matches the predetermined code label, extracting the script code corresponding to the traversed content.

19. The non-transitory storage medium of claim 16, wherein after replacing the script reference tag in the original HTML file with the script code of the corresponding page task, the acts further comprises:
modifying configuration information of the HTML file from the script reference tag of the page task contained in the HTML file to the script code of the page task contained in the HTML file.

20. The non-transitory storage medium of claim 15, wherein executing the script code of the at least one page task comprises:
creating at least one page task instance based on the script code; and
loading the page task instance into at least one created thread for execution; wherein the at least one thread corresponds one-to-one with the at least one page task instance.
